(19) United States
(12) Patent Application Publication
(10) Pub. No.: US 2011/0085018 A1
(43) Pub. Date: Apr. 14, 2011

(54) Multi-User Video Conference Using Head Position Information

(76) Inventors: W. Bruce Culbertson, Palo Alto, CA (US); Ian N. Robinson, Pebble Beach, CA (US)

(21) Appl. No.: 12/772,100

(22) Filed: Apr. 30, 2010

Related U.S. Application Data
(63) Continuation-in-part of application No. 12/576,408, filed on Oct. 9, 2009.

(51) Int. Cl. H04N 7/15

(52) U.S. Cl. 348/14.08; 348/E07.083; 348/14.16

(57) ABSTRACT

The present invention provides a system and method for rendering a video conference. The method includes the steps of: creating a visual representation of a plurality of participants in the video conference, wherein the plurality of participants are divided into two or more subsets; and creating a compact version of the visual representation of at least one of the two or more subsets, wherein the choice of which subsets have a compact version of the visual representation created and displayed is based on the head position of a local participant.

### CROSSREFERENCE TO RELATED APPLICATION

This case is a continuation-in-part of the case entitled “Video Conference” filed on Oct. 9, 2009, having U.S. Ser. No. 12/576,408, which is hereby incorporated by reference in it's entirety.

### BACKGROUND

When viewing participants in a video conference, a participant often utilizes one or more devices to manually adjust camera viewing angles and camera zoom levels of himself/herself and for other participants of the video conference in order to capture one or more participants to view for the video conference. Additionally, the participant often physically manipulates his/her environment or other participants' environment by moving video conference devices around. Once the participant is satisfied with the manipulations, the participant views video streams of the participants as the video conference.

### BRIEF DESCRIPTION OF DRAWINGS

The figures depict implementations/embodiments of the invention and not the invention itself. Some embodiments are described, by way of example, with respect to the following Figures.

FIG. 1 illustrates a block diagram of a video-conferencing system with one or more input devices and a display device according to an embodiment of the invention;

FIG. 2 illustrates an input device configured to track a head position of a local participant viewing a video conference according to an embodiment of the invention;

FIG. 3A shows a plan view of a spatial organization of the remote participants in a video conference virtual model according to one embodiment of the invention;

FIG. 3B shows a video conference rendering viewed by the local participant having a first head position according to one embodiment of the invention;

FIG. 3C shows a video conference rendering viewed by the local participant having an alternative head position according to one embodiment of the invention;

FIG. 4A shows a video conference rendering viewed by a local participant with a first head position according to one embodiment of the invention;

FIG. 4B shows a video conference display being viewed by a local user with a second head position according to one embodiment of the invention;

FIG. 4C shows a video conference display being viewed by a local user with a third head position according to one embodiment of the invention;

FIG. 5A shows a view of the video conference scene of a local user at a first position according to one embodiment of the invention;

FIG. 5B shows a view of the video conference scene of a local user at a second head position according to one embodiment of the invention;

FIG. 5C shows a view of the video conference scene of a local user at a third head position according to one embodiment of the invention;

FIG. 6 is illustrates a system with an embedded Video Conference Application stored on a removable medium being accessed by the system according to an embodiment of the invention.

FIG. 7 is a flow chart illustrating a method for rendering a video conference according to an embodiment of the invention.

The drawings referred to in this Brief Description should not be understood as being drawn to scale unless specifically noted.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent, however, to one of ordinary skill in the art, that the embodiments may be practiced without limitation to these specific details. Also, different embodiments may be used together. In some instances, well known methods and structures have not been described in detail so as not to unnecessarily obscure the description of the embodiments.

This invention is useful in the context of a multi-user video conferencing system, in which multiple participants are displayed on the display screen of a local user. As the number of remote participants gets larger, the amount of detail that can be displayed for any participant can become inadequate if all participants are displayed with equal display area, especially if the display device is small. Yet, typically, the local user is most interested in one or just a few of the remote participants. The invention provides a natural way for the local user to use head position to select a subset of the participants to be displayed so that a larger display area is available for a subset of participants.

The present invention provides a system and method for rendering a video conference, comprising the steps of: creating a visual representation of a plurality of participants in the video conference, wherein the plurality of participants are divided into two or more subsets; creating a compact version of the visual representation of at least one of the two or more subsets, wherein at least one of the two or more subsets is not a compact version, where the choice of which subsets are a compact version is based on the head position of a local participant; determining the screen area allocation to each of the participants, wherein each of the participants in the at least one of the two or more subsets that is not a compact version are provided more screen area on the display than each of the participants in the at least one of the two or more subsets that is a compact version; and displaying at least a portion of the visual representations of the participants to a local participant.

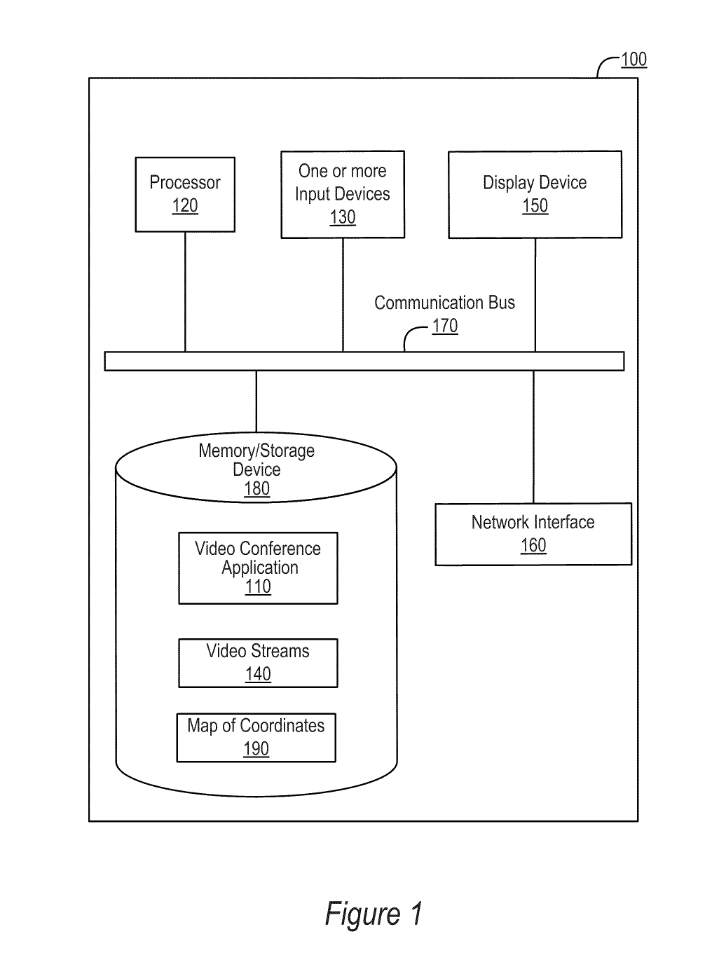

FIG. 1 illustrates a block diagram of a system 100 for rendering a video conference in accordance with one embodiment of the invention. The system 100 shown includes one or more input devices 130 and a display device 150 according to an embodiment of the invention. In one embodiment, the system 100 is a desktop, laptop/notebook, netbook, and/or any other computing device. In another embodiment, the system 100 is a video conference center and/or the system 100 is included as part of the video conference center.

As illustrated in FIG. 1, the system 100 includes a processor 120, a network interface 160, a display device 150, one or more input devices 130, a memory/storage device 180, and a communication bus 170 for the system 100 and/or one or more components of the system 100 to communicate with one another. Additionally, as illustrated in FIG. 1, the memory/storage device 180 stores a video conference application 110, video streams 140 of participants participating in a video conference, and a map of coordinates 190. In other embodiments, the system 100 includes additional components and/or is coupled to additional components in addition to and/or in lieu of those noted above and illustrated in FIG. 1.

As noted above and as illustrated in FIG. 1, the system 100 includes a processor 120 coupled to the system 100. The processor 120 sends data and/or instructions to the components of the system 100, such as one or more input devices 130 and a video conference application 110. Additionally, the processor 120 receives data and/or instruction from components of the system 100, such as one or more input devices 130 and the video conference application 110.

The video conference application 110 can be firmware which is embedded onto the system 100. In other embodiments, the video conference application 110 is a software application stored on the system 100 within ROM or on a storage device 180 accessible by the system 100 or the video conference application 110 is stored on a computer readable medium readable and accessible by the system 100 from a different location. Additionally, in one embodiment, the storage device 180 is included in the system 100. In other embodiments, the storage device 180 is not included in the system, but is accessible to the system 100 utilizing a network interface 160 included in the system 100. The network interface 160 may be a wired or wireless network interface card.

In a further embodiment, the video conference application 110 is stored and/or accessed through a server coupled through a local area network or a wide area network. The video conference application 110 communicates with devices and/or components coupled to the system 100 physically or wirelessly through a communication bus 170 included in or attached to the system 100. In one embodiment the communication bus 170 is a memory bus. In other embodiments, the communication bus 170 is a data bus.

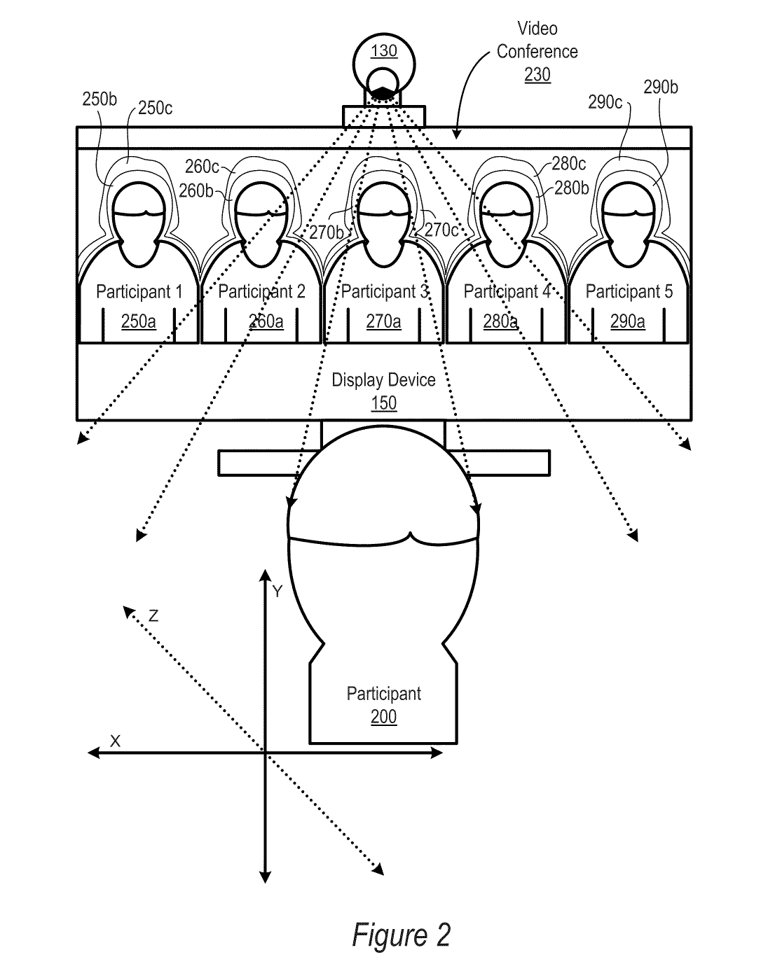

FIG. 2 illustrates an input device 130 configured to track a head position of a local participant 200 viewing a video conference according to one embodiment of the invention. When tracking the head position, the video conference application 110 configures one or more of the input devices 130 to track changes made to the head position of the participant in response to one or more head movements made by the participant. Additionally, the video conference application 110 tracks one or more head movements by configuring one or more of the input devices 130 to track a direction of the head movement made by the participant and an amount of the head movement. In one embodiment, the video conference application 110 additionally considers whether the head movement is turning or leaning to one side, and thus whether the head movement includes a rotation and/or a degree of the rotation.

Referring to FIG. 2 shows a video conferencing system with a plurality of participants (200, 250a-c, 260a-c, 270a-c, 280a-c, 290a-c). According to the invention, the video conferencing system 100 creates a visual representation of the plurality of video conferencing participants. Referring to FIGS. 1 and 2, the video conference application 110 renders and/or re-renders the video conference for display on a display device 150. The video conference application 110 utilizes one or more video streams 140 of participants participating in the video conference when rendering and/or re-rendering the video conference.

The video conference application 110 can organize and render the video conference such that video streams 140 of the participants are displayed so that the visual representation of at least a first subset of participants is given a more compact form. Although different forms can be implemented according to this invention. In one embodiment, a first subset is at least partially spatially compressed to take less visual space on the display device 150. In another embodiment, a first subset of the participants is given a more compact form by at least partially obscuring them by a second subset of participants.

In the embodiment shown in FIG. 2, the video streams 140 of the remote participants (250a-c, 260a-c, 270a-c, 280a-c, 290a-c) are organized such that the participants are shown in a layout that mimics the view of a seated audience. In one embodiment, the rendering of this view is created by segmenting the images of the participants from their backgrounds and are displaying the images of the segmented participants with all background pixels set to transparent. In this case participants in the second (and subsequent) rows may be partially obscured by those in front. In this case, head motion can be used to simulate motion parallax, causing the rows to move at different rates and allowing occluded parts of the row to be revealed.

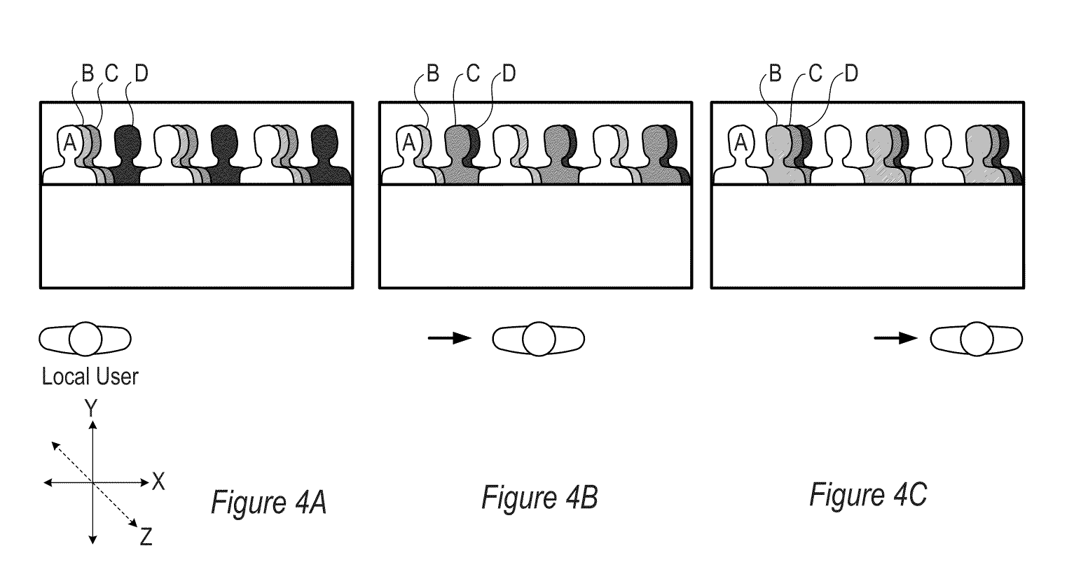

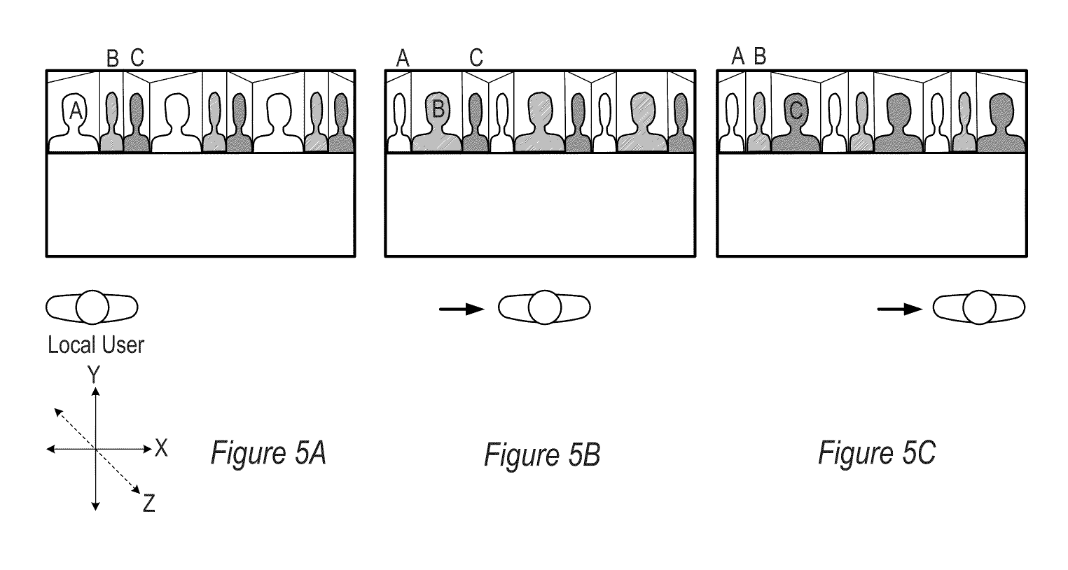

In the embodiment shown in FIG. 2, the participants are arranged in multiple rows. According to the invention, the plurality of participants are divided or grouped into two or more subsets. The subsets are defined by the user or system designer so that the subsets divide the participants based on which participants will take up a more compact screen space and which participants will be given more screen space while being viewed by the local user. Further details on how the participants are divided into subsets is given by example with respect to the embodiments shown in FIGS. 4A-4C and FIGS. 5A-5C.

Further, as illustrated in FIG. 2, in one embodiment, one or more input devices 130 are mounted on a display device 150 configured to display the video conference 230. As noted above, one or more input devices 130 are devices which can be configured by the video conference application to detect and track head movements made by the participant 200. In one embodiment, as illustrated in FIG. 2, one or more input devices 130 are cameras which track the head movements of the participant by utilizing the participant's 200 head or eyes as a reference point while the participant 200 is viewing the video conference 230.

As noted above, in one embodiment, the video conference application 110 will then render or re-render the video conference such that display resources for one or more participants and corresponding video streams 140 of the participants indicated by the local participants head position are increased. Additionally, the video conference application 110 can render or re-render the video conference such that display resources for one or more participant and corresponding video streams 140 for the participants that remain obscured are decreased.

In one embodiment, the virtual representations being viewed by the local user includes the local user 200 (or local participant) and also a plurality of remote participants. In another alternative embodiment, the virtual representations being viewed by the local user only has remote participants. In this alternative embodiment, the remote participants are arranged, relative to the viewpoint of the local user, such that some of them occlude others from the view of the local user. For example, the remote participants could be arranged in rows in front of the local user. Remote participants who are expected to be most often of interest to the local user could be assigned to the front row.

The participants are arranged such that, given any particular remote participant, at least one position of the local user's head in front of the display will bring that remote participant into the local user's view. Thus, the local user can see any remote participant he chooses. Since not all the remote participants are visible at once, the remote participants who are visible can be displayed with more display area than if all were visible.

Referring to FIGS. 1 and 2, once the video conference application 110 has organized and positioned the video streams 140 of the participants, the video conference application 110 can render the video conference for display on a display device 150 coupled to the system 100. The display device 150 is a device that can create and/or project one or more images and/or videos for display as the video conference. In one embodiment, the display device 150 is a monitor and/or television. In other embodiments, the display device 150 is a projector. Once the video conference application 110 has rendered the video conference, a participant can view the video conference on the display device 150.

Further, the view of the video conference scene continues to change and/or be updated as a head position of the local participant changes. A head position of the local participant corresponds to where the participant's head is when viewing the video conference. As noted above, when tracking the head position of the participant, the video conference application 110 configures one or more of the input devices 130 to track changes made to the head position in response to one or more head movements. Additionally, as noted above, when tracking one or more head movements made by the participant, the video conference application 110 tracks a direction of a head movement of the participant, an amount of the head movement, and/or a degree and type of rotation of the head movement. As a result, the view of the scene can be identified, displayed and/or updated in response to a direction of a head movement of the participant, an amount of the head movement, and/or a degree of rotation of the head movement.

A head movement includes any motion made by the participant's head. In one embodiment, the head movement includes the participant moving his head following a linear path along one or more axes. In another embodiment, the head movement includes the participant rotating his head around one or more axes. In other embodiments, the head movement includes both linear and rotational movements along one or more axes. As noted above, in tracking the head movements, one or more input devices 130 can be configured to track a direction of the head movement, an amount of the head movement, and/or a degree of rotation of the head movement. One or more input devices 130 are devices which can capture data and/or information corresponding to one or more head movements and transfer the information and/or data for the video conference application 110 to process.

In one embodiment, the one or more input devices 130 for capturing head movement can include at least one from the group consisting of one or more cameras, one or more depth cameras, one or more proximity sensors, one or more infra-red devices, and one or more stereo devices. In other embodiments, one or more input devices 130 can include or consist of additional devices and/or components configured to detect and identify a direction of a head movement, an amount of the head movement, and/or whether the head movement includes a rotation.

One or more input devices 130 can be coupled and mounted on a display device 150 configured to display the video conference. In another embodiment, one or more input devices 130 can be positioned around the system 100 or in various positions in an environment where the video conference is being displayed. In other embodiments, one or more of the input devices 130 can be worn as an accessory by the local participant.

As noted above, one or more input devices 130 can track a head movement of the participant along an x, y, and/or z axis. Additionally, one or more input devices 130 can identify a distance of the participant from a corresponding input device 130 and/or from the display device 150 in response to a head movement. Further, one or more input devices 130 can be configured to determine whether a head movement includes a rotation. When the head movement is determined to include a rotation, the video conference application 110 can further configure one or more input devices 130 to determine a degree of the rotation of the head movement in order to change the perspective of the view of the scene.

As shown in FIG. 2, the input device 130 can capture a view of the participant's 200 head and/or eyes and use the head and/or eyes as reference points. By capturing the view of the participant's 200 head and eyes, one or more input devices 130 can accurately capture a direction of a head movement, an amount of the head movement, determine whether the head movement includes a rotation, and/or a degree of the rotation.

Additionally, when tracking the head movements, one or more input devices 130 can utilize the participant's head or eyes as a reference point while the participant is viewing the video conference. In one embodiment, the video conference application 110 additionally utilizes facial recognition technology and/or facial detection technology when tracking the head movement. The facial recognition technology and/or facial detection technology can be hardware and/or software based.

In one embodiment, the video conference application 110 will initially determine an initial head or eye position and then an ending head or eye position. The initial head or eye position corresponds to a position where the head or eye of the local participant is before a head movement is made. Additionally, the ending head or eye position corresponds to a position where the head or eye of the participant is after the head movement is made. By identifying the initial head or eye position and the ending head or eye position, the video conference application 110 can identify a direction of a head movement, an amount of the head movement, and/or a degree of rotation of the head movement. In other embodiments, the video conference application 110 additionally tracks changes to the local participant's head and/or eye positions during the initial head or eye position and the ending head or eye position.

In one embodiment, the video conference application 110 can additionally create a map of coordinates 190 of the local participant's head or eye position. The map of coordinates 190 can be a three dimensional binary map or pixel map and include coordinates for each point. As one or more input devices 130 detect a head movement, the video conference application 110 can mark points on the map of coordinates 190 where a head movement was detected.

In one embodiment, the video conference application 110 can identify and mark an initial coordinate on the map of coordinates 190 of where the participant's head or eyes are when stationary, before the head movement. Once the video conference application detects the head movement, the video conference application 110 then identifies and marks an ending coordinate on the map of coordinates 190 of where the participant's head or eyes are when they become stationary again, after the head movement is complete.

The video conference application 110 then compares the initial coordinate, the ending coordinate, and/or any additional coordinates recorded to accurately identify a direction of the head movement, an amount of the head movement, and/or a degree of rotation of the head movement. Utilizing a direction of the head movement, a distance of the head movement, and/or a degree of rotation of the head movement, the video conference application 110 can track a head position of the participant and any changes made to the head position. As a result, the video conference application 110 can adjust the head position to reveal or obscure the participants as desired. As a result, one or more input devices 130 can determine a distance of the participant from one or more input devices and/or the display device 150 and determine how the view seen by the local participant is modified by tracking a direction of the head movement and an amount of the head movement.

Dependent on the head movement or final position of the local user or participant, the video conference application 110 renders and/or re-renders the video conference to increase an amount of display resources for one or more of the participants who are revealed (the non-compact version of the visual representation). Additionally, the video conference application 110 renders and/or re-renders the video conference to decrease the amount of display resources for one or more of the participants who are at least partially obscured (the compact visual representation). In one embodiment, the videoconference application 110 increases and/or decreases display resources for one or more of the participants in response to the head motion of the local participant by simulating motion parallax between participants of the video conference. Although in some embodiments, descriptions are with respect to detecting or tracking the head position (typically the final head position within the desired time interval), embodiments can also be implemented that detect or track the change in head position.

Further, as noted above, the video conference application can modify the view of the screen presented in response to the direction of the head movement, the amount of the head movement, and/or a degree of rotation of the head movement. In addition, the video conference application can render and/or re-render the video conference 230 in response to a modification of the visual representations being presented.

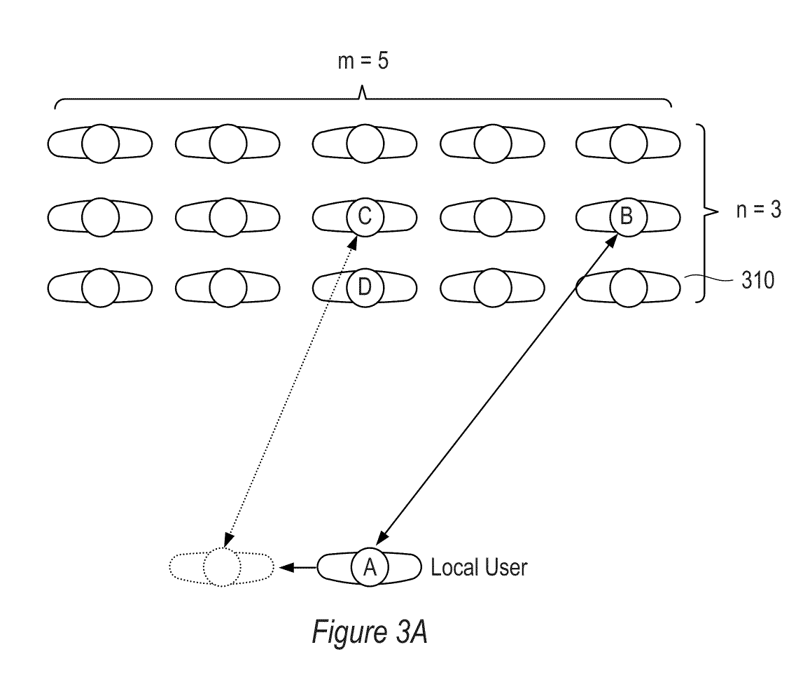

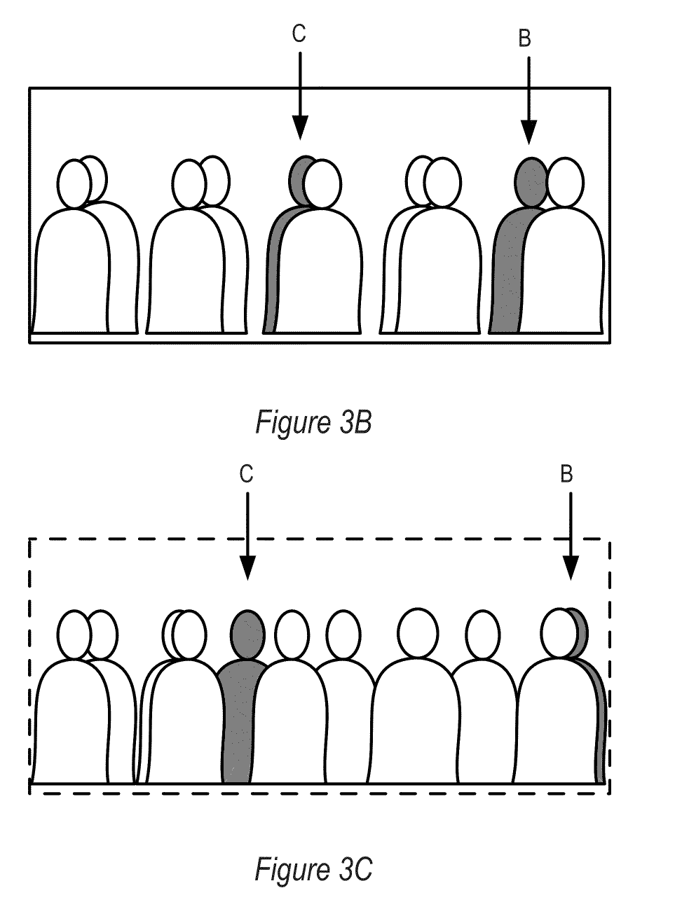

FIG. 3A shows a plan view of a spatial organization of the remote participants in a video conference virtual model according to one embodiment of the invention. As previously stated, the participants of the virtual model can be arranged as a virtual audience in a plurality of rows. In the arrangement shown in FIG. 3A, the participants are shown in virtual n×m array of n=3 rows and m=5 columns. Although in the embodiment shown, there are five participants in the first row of the virtual audience and there are three rows of participants, the number of rows and columns can vary. Because a goal of the invention is to display an image (or virtual representation) that is not too small to communicate a reasonable size view of the participant, a designer could limit the number of participants in the front row of the array based on the screen size of the display and the desirable image size for display.

Referring to FIG. 3A shows a front row 310. Participant D is located in a third or middle position of row 1. Participant C is located in a third position or the middle of row 2, while Participant B is located in a fifth position of row 2. Participant A is a local participant viewing the rendering of the video conference from a first or initial position. In the initial position (and as seen in FIG. 3B which shows a view of Participant A with a first head position), local Participant A can see a virtual representation of Participant B in the second row. However, when Participant A head is located in the initial position (a first head position), Participant A's view of Participant C is blocked. When Participant A moves his head to a second position (the position indicated by the dotted line outline), the image (or virtual representation) of Participant C is no longer blocked by Participant D (as seen in FIG. 3C). FIG. 3C shows the view of Participant A with a second head position.

The system 100 has a means to detect the physical location of the local user's head in front of the display. It uses this information to change the local user's position in the virtual 3D space. For example, if the local user moves physically to the left, then his virtual location is also moved to the left. As a consequence of such a movement, the system renders a new view of the remote participants that is consistent with the new virtual 3D arrangement.

In one embodiment, the system and method includes the step of dividing the plurality of participants into two or more subsets. Although the division of the participants into subsets is discussed with reference to FIGS. 4A-4C and 5A-5C, this is merely for purposes of example. There are multiple ways of defining the subsets. The most critical component for the design is that there are at least two subsets—1) one subset of participants where the visual representation to be displayed are the compact version of the visual representation and 2) one subset of participants where the visual representation to be displayed is not in a compact version or form. Having a portion of the participant in a compact form, allows a subset of the participants to be displayed in a larger visual representative form and take up more screen space (the non-compact form) on the display—a more aesthetically pleasing display as this larger display allows the local user to see more visual detail of that subset of remote participants, enabling the local user to better see expressions, etc. of the remote participants in this subset.

FIGS. 4A-4C illustrate a series of head positions for the local user and the viewpoints associated with the head position according to one embodiment of the present invention. In the embodiment shown in FIGS. 4A-4C (similar to that shown in FIGS. 2-3), the participants are arranged or composited in rows, where a first subset of the participants (behind the front row) are at least partially obscured by a second subset of participants (the front row). In this embodiment, the compact form of the visual representation is implemented by obscuring the second subset of participants behind the first subset of participants.

As illustrated in FIGS. 4A-C, in one embodiment, the local participant 400 makes a linear head movement 430 along the x axis, shifting to the right. As a result, the video conference application detects the head movement and identifies by his/her head movement that a particular subset of participants should be revealed and/or obscured. As the local viewer moves their head further and further along the x axis (to the right), a different subset of remote participants is revealed or obscured.

Although in the embodiment shown in FIGS. 4A-C and also in FIGS. 5A-C show the local participant moving to the right along an x axis, to change which subsets of participants are associated with a compact visual representation, other head position movements are possible. For example, in one embodiment the head position of the participant changes the subset of participants by leaning or orientating his head more to the right or left or alternatively, by moving more to the front or back. In another embodiment the head position of the participant changes the subset of the participants by turning or rotating his head position to the right or left. In another embodiment, the local participant moves closer or further away from the display along the z axis. The important criteria is that a change in head position is detected. In one embodiment, the amount of head position change or movement necessary to change the subset of participants may be set by the user or system designer. However, the value of the minimum predetermined change amount should be detectible by the input device.

FIG. 4A shows a video conference rendering viewed by a local participant with a first head position according to one embodiment of the invention. In the embodiments shown in FIG. 4A-4C, color is indicative of depth with the lightest color indicated the row that is the closest to the local participant and the darkest color indicating the row that is the furthest back from the local participant. For example, the white color Participants (Participant A) are in the front row, followed by a slightly darker Participants (Participant B) in the second row, followed by a slightly darker Participant (Participant C) in the third row, followed by the darkest Participant (Participant D).

Referring to FIG. 4A shows a view of the video conference by the local participant with a first head position. When the local participant's head is in the position shown in FIG. 4A, all of the Participant Ds are revealed. FIG. 4B shows a view of the video conference scene of a local user at a second head position. When the local participant's head is in the position shown in FIG. 4B, Participant Cs are revealed and the Participant Ds (that were previously revealed) are now mostly obscured behind Participant Cs. FIG. 4C shows a view of the video conference scene of a local user at a third head position. When the local participant's head is in the position shown in FIG. 4C, Participant Bs are revealed and the Participants C and D (that were previously revealed) are now mostly obscured behind Participant Bs.

Although the description in the prior paragraph references obscuring (compact version of visual representation) and revealing participants (non-compact version of visual representation), the description can also be made with respect to determining which subset the visual representation is in, based on the head position of the local participant. For example, FIG. 4A shows a video conference rendering viewed by a local participant with a first head position according to one embodiment of the invention. Referring to the first head position shown in FIG. 4A, we can divide the participants into two groups a first subset which shows the non-compact version of the visual representation (Participants A and D are in this subset) and a second subset which shows a compact version of the visual representation (Participants B and C are in this subset.) As can be seen in FIG. 4A, each participant in the second subset (the compact version of the visual representation) receives less screen space on the display.

FIG. 4B shows a video conference rendering viewed by a local participant with a second head position. As can be seen by referring to FIG. 4B, the participants in the subsets change as the local user's head position changes. For example, in the first subset which shows the non-compact version of the visual representation—the participants change to include Participants A and C and the second subset which shows a compact version of the visual representation changes to include Participants B and D. As can be seen in FIG. 4B, the participants B and D in the second subset (the compact version of the visual representation) receive less screen space on the display.

FIG. 4C shows a video conference rendering viewed by a local participant with a third head position. Again, the participants in the subsets change as the local user's head position changes. For example, in the first subset which shows the non-compact version of the visual representation—the participants change to include Participants A and B and the second subset which shows a compact version of the visual representation changes to include Participants C and D. As can be seen in FIG. 4B, the participants C and D in the second subset (the compact version of the visual representation) receive less screen space on the display.

In the embodiment shown in FIGS. 4A-4C, at all times the front row (the at least second subset) is composited or arranged so that they are in front of the at least first subset of participants (rows behind the front row). In the embodiments shown, the successive rows (rows B, C, D) slide into view between front row images as the viewer moves his head. The motion of the participants shown in FIGS. 4A-4C is similar to motion parallax, however, true motion parallax would not give as clear a separation of the heads of the participant being viewed. The separation is exaggerated in this case, in order to provide clearer view of the participants to the local participant 200.

In one embodiment, the video conference application simulates motion parallax between the participants by rendering and/or re-rendering the video conference such that one or more of the participants appear to overlap one another and/or shift along one or more axes at different rates from one another. The video conference can scale down, crop, and/or vertically skew one or more video streams to simulate one or more of the participants overlapping one another and shifting along one or more axes at different rates from one another. Additionally, more display resources are allocated for the remote participant who is revealed (originally obscured but becomes unobscured) based on the head movement of the local participant 200, and less display resources are allocated for the participants that are obscured.

FIG. 5A shows a local participant's view of the video conference when the local participant's head is in a first position according to one embodiment of the invention. In the embodiment shown in FIG. 4A-4C, the virtual audience is composited in rows. In the embodiment shown, in FIGS. 5A-5C, the virtual audience is composited in a single row as a series of corrugated or folded surfaces. As previously stated, the present invention provides a view of a plurality of participants so that at least a first subset of participants is at least partially spatially compressed or obscured by a second subset of participants. Thus in this case, the compact version of the visual representation of the participants is a spatially compressed version of the original visual representation.

In FIGS. 5A-C, instead of all images of the participants facing the local user, at least a first subset of the images are displayed on a representative surface that is angled away from the local user. Although in the embodiment shown in FIGS. 5A-5C, the local user is shown facing the display screen, in another embodiment the local user changes his head position so that his head is facing the virtual angled surface.

FIG. 5A shows a local participant's view of the video conference when the local participant's head is in a first position according to one embodiment of the invention. When the local participant's head is in the position shown in FIG. 5A, all of the Participant As are revealed. FIG. 5B shows a view of the video conference scene of a local user at a second head position. When the local participant's head is in the position shown in FIG. 5B, Participant Bs are revealed and the Participant As (that were previously revealed) are now spatially compressed and the surface is angled away from the local participant. FIG. 5C shows a view of the video conference scene of a local user at a third head position. When the local participant's head is in the position shown in FIG. 5C, Participant Cs are revealed and the Participants A and B (that were previously revealed) are now spatially compressed.

Although the description in the prior paragraph references spatially compressing participants (compact version of visual representation) and revealing other participants (non-compact version of visual representation), the description can also be made with respect to which subset the visual representation is in, based on the head position of the local participant. For example, FIG. 5A shows a video conference rendering viewed by a local participant with a first head position. Referring to the first head position shown in FIG. 5A, we can divide the participants into two groups—a first subset which shows the non-compact version of the visual representation (Participant A is in this subset) and a second subset which shows a compact version of the visual representation (Participants B and C are in this subset.) As can be seen in FIG. 5A, each participant in the second subset (the compact version of the visual representation) receives less screen space on the display.

FIG. 5B shows a video conference rendering viewed by a local participant with a second head position. As can be seen by referring to FIG. 5B, the participants in the subsets change as the local user's head position changes. For example, in the first subset (the non-compact version of the visual representation)—the participant changes to Participant B and the second subset (which shows a compact version of the visual representation) changes to include Participants A and C. As can be seen in FIG. 5B, the participants B and C in the second subset (the compact version of the visual representation) receive less screen space on the display.

FIG. 5C shows a video conference rendering viewed by a local participant with a third head position. Again, the participants in the subsets change as the local user's head position changes. For example, in the first subset (which shows the non-compact version of the visual representation)—the participant in the first subset changes to Participant C and the second subset (which shows a compact version of the visual representation) changes to include Participants A and B. As can be seen in FIG. 5C, the participants A and B in the second subset (the compact version of the visual representation) receive less screen space on the display.

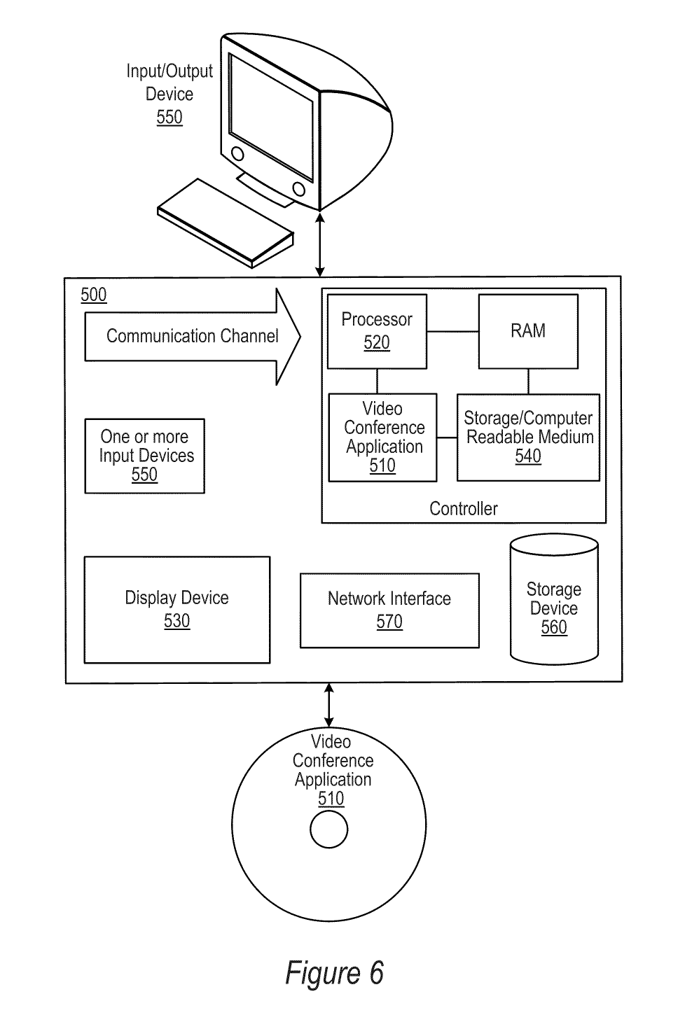

FIG. 6 illustrates a system 500 with an embedded Video Conference Application 510 and a Video Conference Application 110 stored on a removable medium being accessed by the system 500 according to an embodiment of the invention. For the purposes of this description, a removable medium is any tangible apparatus that contains, stores, communicates, or transports the application for use by or in connection with the system 500. As noted above, in one embodiment, the Video Conference Application 510 is firmware that is embedded into one or more components of the system 500 as ROM. In other embodiments, the Video Conference Application 510 is a software application which is stored and accessed from a hard drive, a compact disc, a flash disk, a network drive or any other form of computer readable medium that is coupled to the system 500.

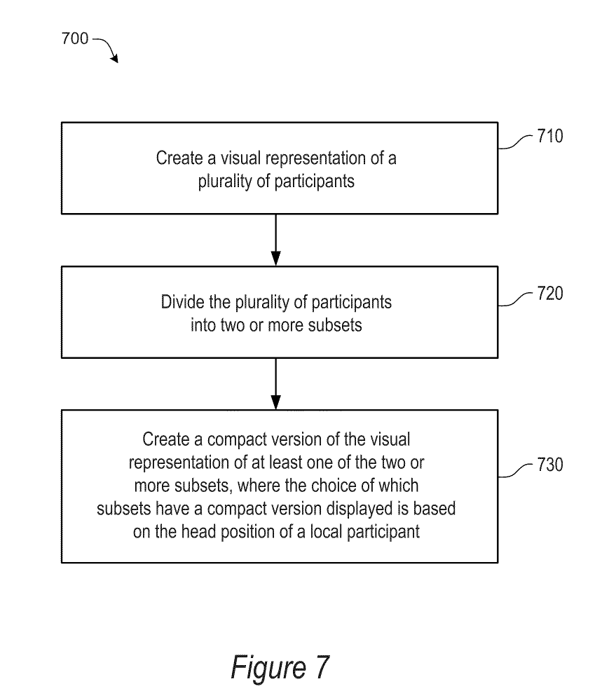

FIG. 7 is a flow chart illustrating a method for rendering a video conference according to an embodiment of the invention. The method of FIG. 7 uses a system coupled to one or more input devices, a display device, one or more video streams, and a video conference application. In other embodiments, the method of FIG. 7 uses additional components and/or devices in addition to and/or in lieu of those noted above and illustrated in FIGS. 1, 2, 3, 4 and 5.

FIG. 7 is a flow chart illustrating a method 700 for rendering a video conference according to an embodiment of the invention. Referring to FIG. 7, the first step in rendering the video conference is creating a visual representation of a plurality of participants in the video conference (710). The plurality of participants are divided into at least two subsets (720). One of the at least two subsets includes a group of participant's whose visual representation (for the relevant local user head position) is not a compact version of the originally created visual representation. Another of at least two subsets includes a group of participant's whose visual representation) is a compact version of the originally created visual representation.

After dividing the participant into at least two subsets, a compact version of the visual representations of at least one of the two subsets is created, where the choice of which of the two subsets is chosen for creation of a compact version is based on the head position of the local user (730). For at least one of the two subsets, a compact visual representation is not created. For this at least one subset, the original visual representation created in step 710 is used.

After creating a compact version of the visual representations of at least one of the two subsets of participants, the screen area allocation is determined. The display screen is allocated so that the participants in the subset in the two or more subsets that is not a compact version of the visual representation, is provided more screen area on the display screen than each of the participants in the at least one of the two or more subsets that have a compact version of their visual representation.

After the screen allocation is determined, the visual representations of at least a portion of the participants is displayed to the local user. The method is then complete, or the video conference application can continue to repeat the process or any of the steps disclosed in FIG. 7 as the head position of the local user viewing the video conference is changed. In other embodiments, the method of FIG. 7 includes additional steps in addition to and/or in lieu of those depicted in FIG. 7.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

What is claimed is:

1. A method for rendering a video conference, comprising the steps of:
creating a visual representation of a plurality of participants in the video conference, wherein the plurality of participants are divided into two or more subsets; and
creating a compact version of the visual representation of at least one of the two or more subsets, wherein the choice of which subsets have a compact version of the visual representation created and displayed is based on the head position of a local participant.

2. The method recited in claim 1 further including the step of;
displaying to the local participant at least a portion of the compact version of the visual representations of the at least one of the two or more subsets
displaying to the local participant at least a portion of the visual representations of the at least one of the two or more subsets that is not chosen for creating a compact version of the visual representation that is available for display.

3. The method recited in claim 1, further including the step of:
determining the screen area allocation for the visual representations of each of the participants, wherein each of the participants in the at least one of the two or more subsets that is not associated with a compact version of the visual representation are provided more screen area on the display than each of the participants in the compact versions of the visual representation.

4. The method recited in claim 1, wherein the choice of which subsets have a compact version of the visual representation created and displayed can be changed.

5. The method recited in claim 5, wherein the participants in the two or more subsets are changed by the local participant changing his head position.

6. The method recited in claim 5, wherein the participants in the two or more subsets are changed by the local participant changing his head position by a predetermined change amount.

7. The method recited in claim 1 wherein the compact version of the visual representation is at least partially obscured.

8. A system comprising:
A processor:
A display device configured to display a video conference of a plurality of participants;
One or more input devices configured to track a head position of a local participant viewing the video conference; and
A video conference application executable by a processor from a computer readable memory and configured to
create a visual representation of the plurality of participants in the video conference, wherein the plurality of participants are divided into two or more subsets; and
creating a compact version of the visual representation of at least one of the two or more subsets, wherein the choice of which subsets have a compact version of the visual representation created and displayed is based on the head position of a local participant.

9. The system recited in claim 8 further wherein the video conference application is further configured to;
display to the local participant at least a portion of the compact version of the visual representations of the at least one of the two or more subsets
displaying to the local participant at least a portion of the visual representations of the at least one of the two or more subsets that is not chosen for creating a compact version of the visual representation that is available for display.

10. The system recited in claim 8 further wherein the video conference application is further configured to;
Determine the screen area allocation for the visual representations of each of the participants, wherein each of the participants in the at least one of the two or more subsets that is not associated with a compact version of the visual representation are provided more screen area on the display than each of the participants in the compact versions of the visual representation.

11. The system recited in claim 8 wherein the choice of which subsets have a compact version of the visual representation created and displayed can be changed.

12. The system recited in claim 8, wherein the participants in the two or more subsets are changed by the local participant changing his head position.

13. The system recited in claim 12, wherein the participants in the two or more subsets are changed by the local participant changing his head position by a predetermined change amount.

14. The system recited in claim 1 wherein the compact version of the visual representation is at least partially obscured.

15. A computer-readable program in a computer-readable medium comprising: a video conference application configured to
Create a visual representation of a plurality of participants in the video conference, wherein the plurality of participants are divided into two or more subsets; and
Create a compact version of the visual representation of at least one of the two or more subsets, wherein the choice of which subsets have a compact version of the visual representation created and displayed is based on the head position of a local participant.

16. The computer readable program recited in claim 15 further configured to
display to the local participant at least a portion of the compact version of the visual representations of the at least one of the two or more subsets
display to the local participant at least a portion of the visual representations of the at least one of the two or more subsets that is not chosen for creating a compact version of the visual representation that is available for display.

17. The computer readable program recited in claim 15, further configured to:
determine the screen area allocation for the visual representations of each of the participants, wherein each of the participants in the at least one of the two or more subsets that is not associated with a compact version of the visual representation are provided more screen area on the display than each of the participants in the compact versions of the visual representation.

18. The computer readable program recited in claim 15, wherein the choice of which subsets have a compact version of the visual representation created and displayed can be changed.

19. The method recited in claim 18, wherein the participants in the two or more subsets are changed by the local participant changing his head position.

20. The system recited in claim 18, wherein the participants in the two or more subsets are changed by the local participant changing his head position by a predetermined change amount.
